(19) United States
(12) Patent Application Publication
(10) Pub. No.: US 2006/0187081 A1
(43) Pub. Date: Aug. 24, 2006

(54) Lighting system and method and apparatus for adjusting same

(75) Inventors: Jennifer L. Gloisten, Farmingville, NY (US); Kevin J. Cannarili, Medford, NY (US); Peter Buitenkant, Dix Hills, NY (US); Glenn T. Schmidt, Selden, NY (US); Frederick Reisfeld, Commack, NY (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: B/E Aerospace, Inc., Wellington, FL (US)

(21) Appl. No.: 11/345,260

(22) Filed: Jan. 31, 2006

Related U.S. Application Data
(60) Provisional application No. 60/648,896, filed on Feb. 1, 2005.
(60) Provisional application No. 60/676,274, filed on Apr. 29, 2005.

(51) Int. Cl. G05B 19/02

(52) U.S. Cl. 340/825.22

(57) ABSTRACT

A lighting system and method and apparatus for adjusting same are described. The lighting system has LED lighting units. To adjust a lighting unit, a programmer is connected to the lighting unit, lighting information (such as color or brightness) is input into the programmer (either manually or electronically), and data representing the lighting information is transmitted from the programming device to the lighting unit. The data is stored in the lighting unit, and one or more of the LEDs emits light that corresponds to the transmitted data.

### CROSS-REFERENCE TO RELATED APPLICATIONS

The patent application claims the benefit of the filing date of U.S. Provisional Application No. 60/648,896, filed Feb. 1, 2005 and further claims the benefit of U.S. Provisional Application No. 60/676,274, filed Apr. 29, 2005.

### FIELD OF THE INVENTION

This invention relates generally to LED lighting and, more particularly, to an LED lighting system, and a method and system for adjusting the lighting system.

### BACKGROUND OF THE INVENTION

With the introduction of LED light fixtures, new maintenance challenges have appeared. For example, unlike standard incandescent lights, which provide constant tint and intensity, the tint and intensity of LEDs can vary considerably, depending on the age of the LEDs, the progress of LED technology, and the quality of the semiconductor material used in the LEDs. Thus, changing an LED-based light fixture can be more challenging than changing an incandescent light, in that a new LED-based light fixture must be “matched” to the existing fixtures in order to maintain a uniform appearance. This can require a considerably amount of trial and error on the part of a lighting technician. If a proper “match” is not made, then the aesthetic quality of the lighting system can be diminished.

### SUMMARY

In accordance with the foregoing, a method for adjusting an LED lighting unit is provided. In an embodiment of the invention, the lighting unit has multiple LEDs. To adjust the lighting unit in this embodiment, a programmer is connected to the lighting unit, lighting information (such as color or brightness) is input into the programmer (either manually or electronically), and data representing the lighting information is transmitted from the programming device to the lighting unit. The data is stored in the lighting unit, and one or more of the LEDs emits light that corresponds to the transmitted data.

In an embodiment, the color of the one or more of the LEDs changes. The light being emitted by the changed LEDs is then observed (either by a person or by a photosensitive device). If it is determined (the determination being made by a person or my a computer processor) that the light being emitted by “changed” LEDs is not the correct color (or brightness), then, based on that determination, new lighting information is input into the programmer.

In another embodiment, the color being emitted by the lighting unit is compared to one or more other lighting units (either based on human observation or using a photosensitive device). Then, based on the comparing step, the information that is to be input during the inputting step is determined.

In another embodiment, the lighting unit contains a microprocessor that transmits, to the LEDs, a signal representative of the data received from the programmer.

In another embodiment, a user input mechanism (such as a button) that triggers the storing of the data in the lighting unit is activated.

In another embodiment, the programmer is connected to a second lighting unit, and lighting information (which may be stored in a memory of the second lighting unit) is transferred from the second lighting unit to the first lighting unit, thereby enabling the first lighting unit to “match” the qualities (such as color and brightness) of the second lighting unit.

Yet another embodiment of the invention is an apparatus for adjusting an LED lighting unit. In this embodiment, the apparatus (which may be a portable handheld unit) has an input mechanism (a manual one, such as a button, switch, lever, dial, or knob; or an electronic input mechanism, such as an RS-485 interface) that receives lighting information. The lighting information represents a characteristic (such as color or brightness) of the light that is supposed to be emitted from the LED lighting unit. The apparatus in this embodiment also has a memory that stores the received lighting information, a feedback mechanism (such as a dial, digital readout, or LED indicator) that shows the user what lighting information has been received from the user, an interface (such as a plug or data port) that connects to the LED lighting unit, and a controller. The controller processes the received lighting information, retrieves the lighting information from the memory, and transmits the information to the LED lighting unit via the interface.

In another embodiment of the apparatus, the input mechanism has multiple controls, and each control is associated with a different color of LED of the lighting unit.

In another embodiment of the apparatus, the input mechanism is an interface that connects to a second LED lighting unit. In this embodiment, the controller executes software for downloading the lighting information from the second LED lighting unit.

In another embodiment, the apparatus has a mechanism that indicates whether the lighting information has been stored.

In another embodiment, the lighting information is for LEDs of at least three different colors.

Still another embodiment of the invention is a lighting system. The lighting system of this embodiment has a programmer, which itself includes a user input mechanism that receives color and brightness information from a user, a communications interface, and a microcontroller that transmits the color and brightness information via the communications interface. The lighting system in this embodiment also has a lighting unit coupled to the programmer. The lighting unit itself includes a communications interface, and a microcontroller that receives the color and brightness information via the communications interface of the lighting unit. The microcontroller in this embodiment transmits a pulse width modulated signal representative of the color and brightness information to one or more light emitting diodes, which emit light in response to the signal. The lighting unit in this embodiment also has a memory for storing the color and brightness information.

In an embodiment, the apparatus has a feedback mechanism that indicates to the user whether the color and brightness information has been transmitted from the programmer to the lighting unit.

### BRIEF DESCRIPTION OF THE DRAWINGS

FIG. 1 illustrates an LED-based wash lighting system for an aircraft, to which an embodiment of the invention may be applied;

FIG. 1A shows alternate LED layouts for the system of claim 1;

FIG. 2 illustrates an example of an electrical infrastructure that may be employed in the system of FIG. 1;

FIG. 3 shows two examples of possible implementations of the driver stages;

FIG. 4 shows example implementations of the slew rate control;

FIG. 5 illustrates an example of a housing that may be used for each light unit (from FIG. 1) in an embodiment of the invention;

FIG. 6A shows an example of how the each light unit (from FIG. 1) may be assembled and placed in a wall mount of an aircraft cabin in an embodiment of the invention;

FIG. 6B shows thermal material inserted between the drive circuitry and the housing;

FIG. 7 shows an embodiment of a method and apparatus for adjusting an LED light in the wash lighting system;

FIG. 8 is an end view of a light fixture that may be used in the wash lighting system;

FIG. 9 illustrates an embodiment of a programmer communicatively linked to a lighting unit of the wash lighting system;

FIG. 10 illustrates logic used with the programmer in an embodiment of a lighting unit;

FIG. 11 illustrates an electrical infrastructure that may be employed in the wash lighting system;

FIG. 12 illustrates an electrical infrastructure that may be employed in the wash lighting system; and

FIG. 13 illustrates an input power conditioning circuit and associated voltage regulator circuits that may be used in the wash lighting system.

### DETAILED DESCRIPTION

The invention is generally directed to an LED lighting system, and a method and apparatus for adjusting an LED lighting system. The example use to which the LED lighting system described herein is applied is as an aircraft wash lighting system. However, it is to be understood that the lighting system can be deployed in a variety of environments. Furthermore, it is to be understood that the adjustment method and apparatus can be used in conjunction with any sort of LED light or lighting system.

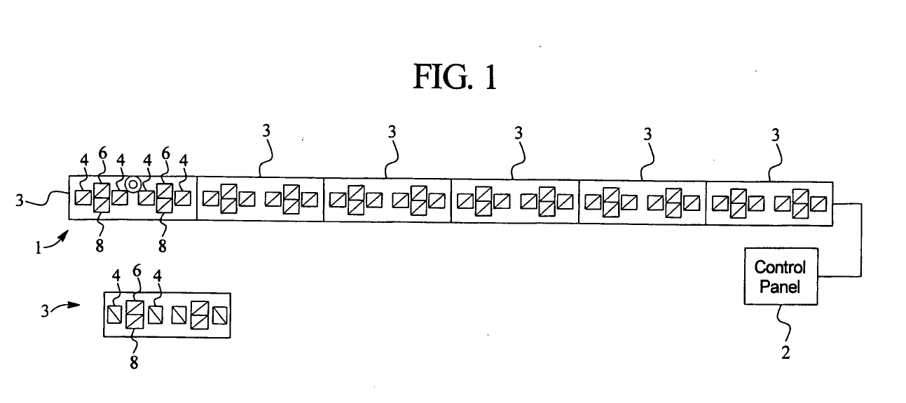

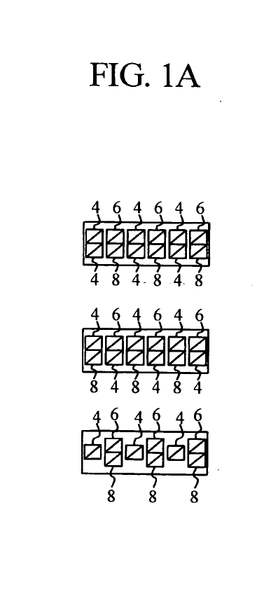

Referring to FIG. 1, an example of an aircraft cabin wash lighting system will now be described. The system, generally labeled 1, includes a control panel 2 and one or more light units 3. The light units 3 may be linked together into segments. The control panel 2 is communicatively linked to the light units 3. Each light unit 3 has white lights 4, and amber lights 6. Additionally, each light unit has additional lights 8, which may be either blue or red. For convenient reference, each of these additional lights 8 will be referred to as blue lights, although it should be understood that they can be either red or blue or both. Unless otherwise specified, all lights referred to herein may use light emitting diodes (LEDs) as their source of illumination. In the example depicted in FIG. 1, the white lights 4 are lined up along a single axis, while the amber and blue lights are disposed in amber/blue pairs, in which each pair is located in between two white lights, with the one of the pair being offset to one side of the axis, and the other of the pair being offset to the other side of the axis. This is just one of many possible arrangements of lights, however. As shown in FIG. 1A, other arrangements are possible. Furthermore, while the light units are depicted as being straight segments, the system may also include curved light unit segments that can be used to mount the chains of light units around corners in the aircraft cabin. In one implementation, the light units weigh 2.2 oz. per foot and come in a variety of lengths, including 9, 10.5, 12, 15, 28.5, and 30 inches.

The amber lights of the system depicted in FIG. 1 serve to make the wash lighting warmer. The warmness or coolness of the lights may be controlled by a crew member using the control panel 2. For example, there may be a control mechanism, such as a switch (e.g. momentary switch, rotary switch, etc.), or a sliding control (slider), labeled “warmth” on the control panel. To make the light warmer, the crew member actuates the control mechanism. In another example, the desired warmth of the wash lighting is preset, and the intensity of the amber LEDs is set accordingly. In either of the two example implementations, the control mechanism at the control panel 2 would control the overall light intensity level and would be used to brighten and dim the white LEDs and the amber LEDs together. The blue lights may similarly be controlled by a control mechanism. Alternatively, the blue lights may be controlled by an on/off switch at the control panel 2. For example, the control panel may have a “night” switch, such that when a crew member toggles the switch, the amber lights shut off, the white lights dim or shut off, and the blue lights are activated. This gives the cabin the feel of nighttime, thereby helping the passengers relax and sleep.

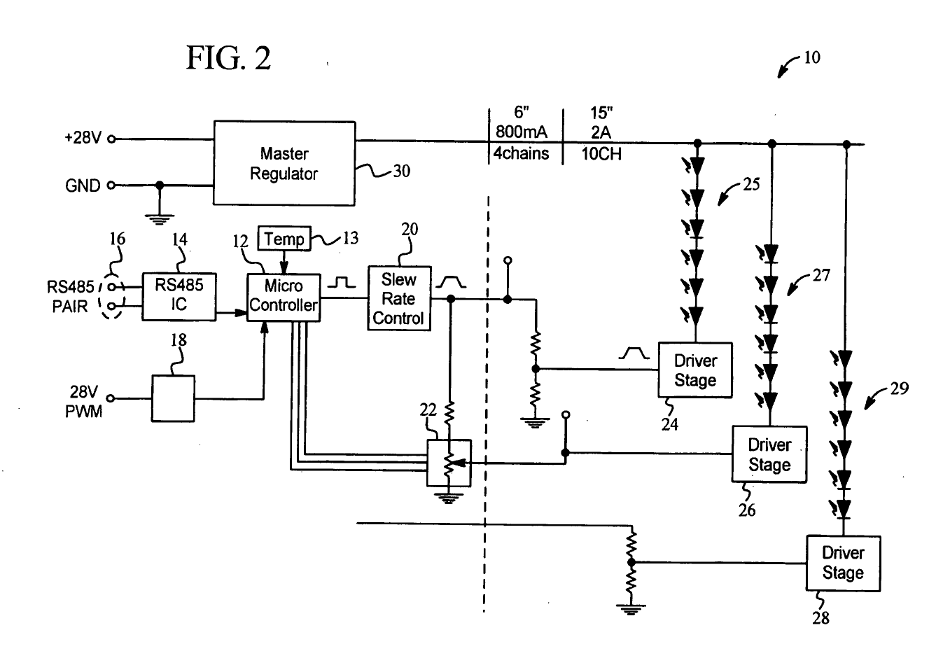

An example of an electrical infrastructure that may be employed in the system 1 of FIG. 1 will now be described with reference to FIG. 2. The infrastructure, generally labeled 10, includes a microcontroller 12 communicatively linked to an RS-485 integrated circuit (IC) 14, and a power supply 18 that provides power to the microcontroller 12. A pair of wires 16 links the IC 14 to the control panel 2 (shown in FIG. 1) and carries control and data signals to the IC 14. The control and data signals represent tint and intensity information. The IC 14, in turn provides the control and data signals to the microcontroller 12 in a form understandable to the microcontroller 12. A temperature sensor 13 is also communicatively linked to the microcontroller. In an embodiment of the invention, the microcontroller 12 and the temperature sensor 13 are both contained within each individual light unit 3 of FIG. 1.

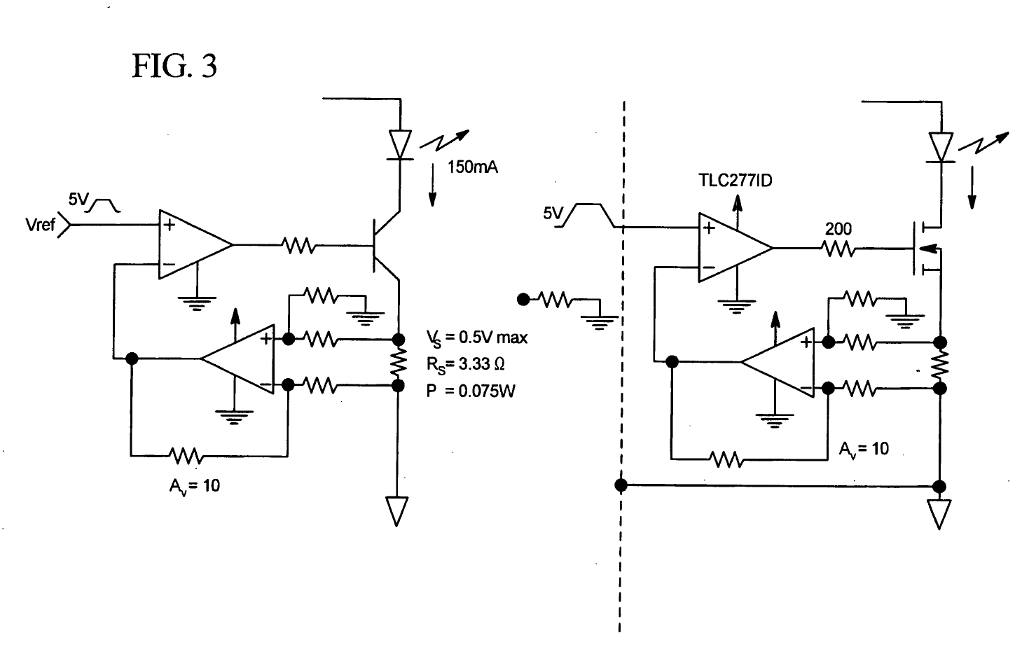

The LEDs that provide illumination for the white, amber and blue lights of the individual light units 3 from FIG. 1 are depicted in FIG. 2 as white LEDs 25, amber LEDs 27, and blue LEDs 29. The white LEDs 25, amber LEDs 27, and blue LEDs 29 are each driven by respective driver stages 24, 26 and 28. Although there are many possible ways to apportion driver stages among LEDs, according to one implementation, one driver stage drives four LEDs. FIG. 3 shows two examples of possible ways of implementing the driver stages.

The electrical infrastructure 10 also includes a slew rate control 20 and a digital potentiometer 22 for the amber LEDs 27. Although not depicted in FIG. 2, the infrastructure 10 also includes a digital potentiometer for the blue LEDs 29. The slew rate control 20 and the digital potentiometer 22 are each electrically coupled o the microcontroller 12. The signals from the slew rate control 20 (which represent the desired intensity of the white LEDs 25) are used as inputs to the digital potentiometer 22 of the amber LEDs 27. As a result, the intensity of the amber LEDs 27 follows the intensity of the white LEDs 25.

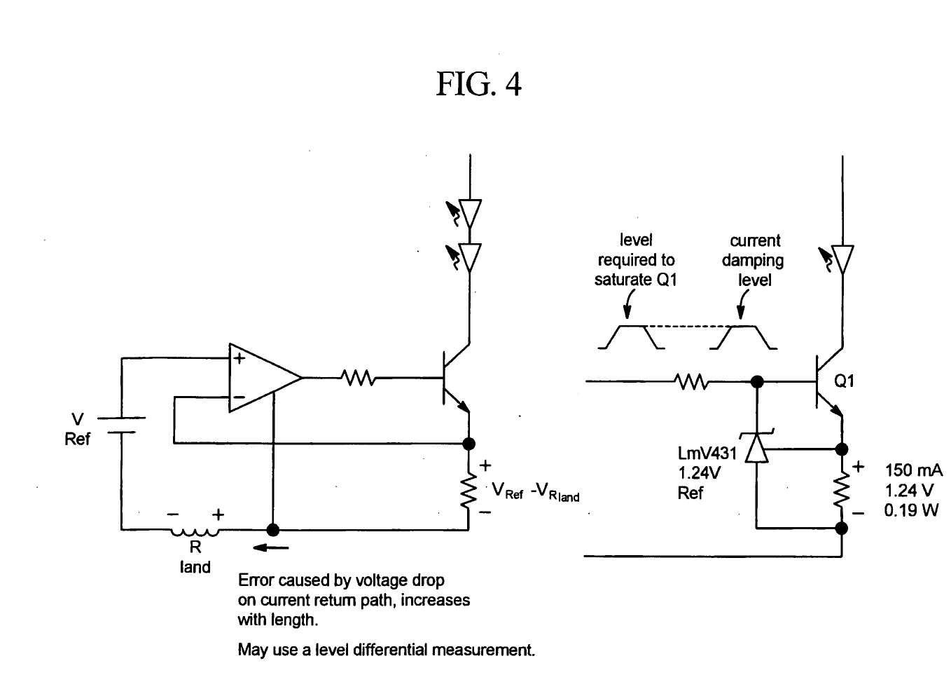

The slew rate control 20 receives pulse width modulated (PWM) signals from the microcontroller 12, conditions those signals, and transmits the conditioned signals to the driver stage 24 for the white LEDs 25, the digital potentiometer 22 for the amber LEDs 27, and the digital potentiometer for the blue LEDs 29. In conditioning the signals, the slew rate control 20 smoothes the edges of the PWM signals generated by the microcontroller 12 so as to reduce electromagnetic interference (EMI). Example implementations of the slew rate control are depicted in FIG. 4.

The LEDs of each color are electrically connected in series strings. For example, groups of the white LEDs of a light unit are connected in a series string, groups of the amber LEDs of the light unit are connected in a series string, and groups of the blue LEDs of a light unit are connected in a series string. Each series string of LEDs is configured as follows: the driver stage is electrically connected at one end of the series string and a switching regulator 30 is connected to the other end of the series string. A master switching regulator 30 (shown in FIG. 2) serves multiple light units 3 (shown in FIG. 1).

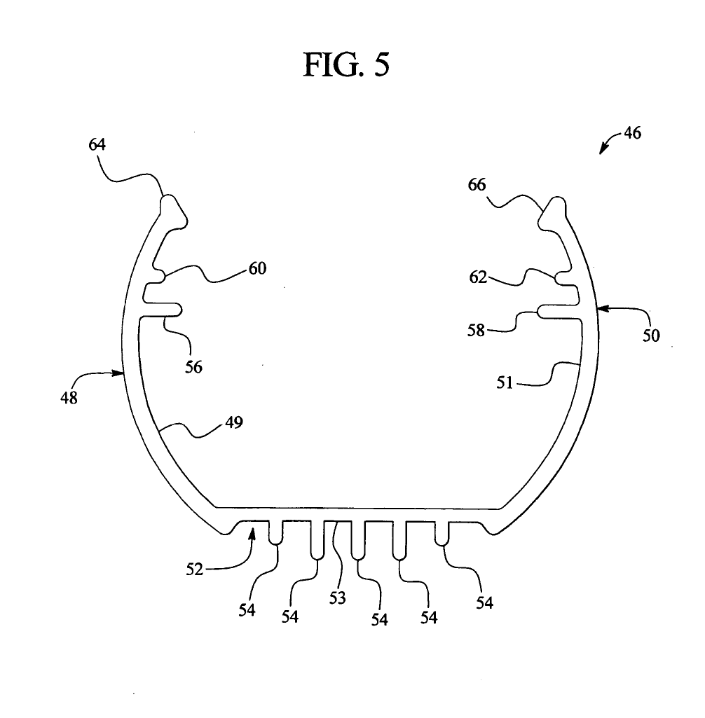

Referring to FIG. 5, each light unit 3 (from FIG. 1) is disposed within a housing 46. The housing 46, which may be made of an aluminum alloy, has a first arcuate side 48, a second arcuate side 50, and a substantially straight bottom 52. The housing 46 is open at the top, with the bottom 52 located between, and formed into a unitary body with, the first side 48 and the second side 50. The first side 48 has an inner surface 49, from which a first shelf 56 and a second shelf 60 extend. The second side 50 has an inner surface 51, from which a third shelf 58 and a fourth shelf 62 extend. The bottom 52 has an outer surface 53 from which a series of fins 54 extends. At the end of the first side 48 farthest from the bottom 52 is a first lip 64, which is generally triangularly shaped. At the end of the second side 50 farthest from the bottom 52 is a second lip 66, which is generally triangularly shaped.

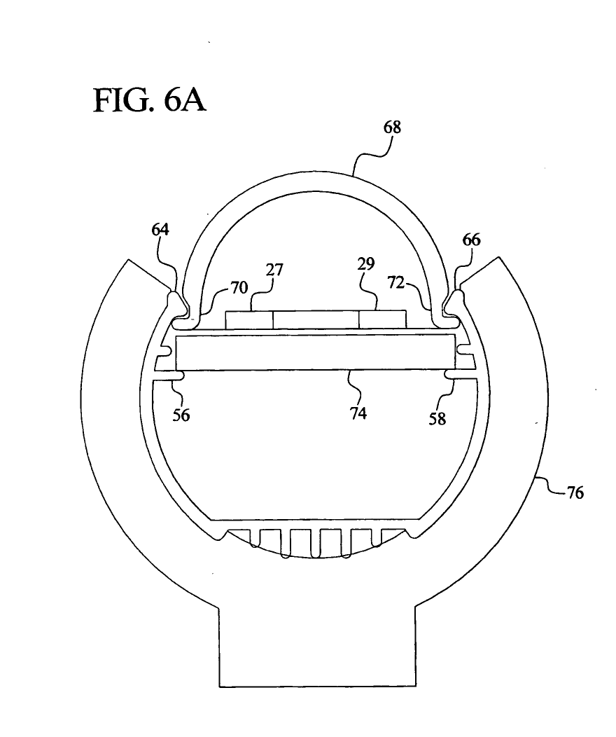

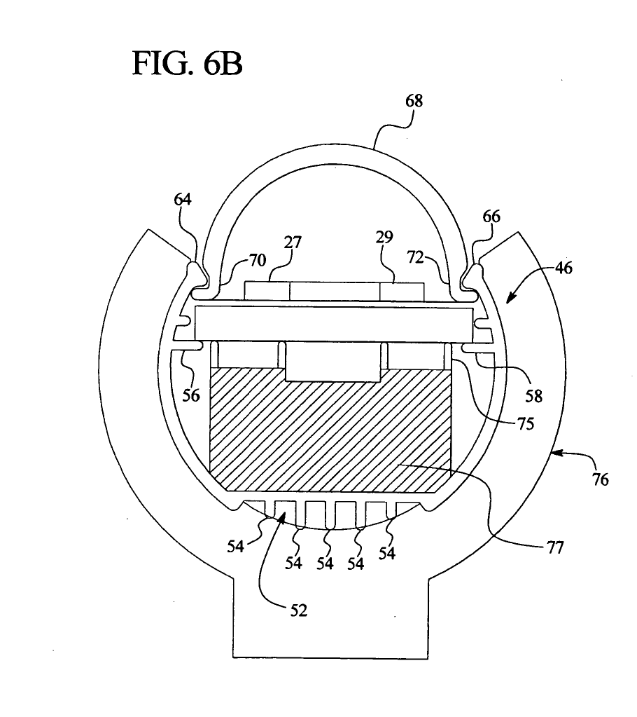

Turning now to FIGS. 6A and 6B, an example of how the each light unit 3 (from FIG. 1) may be assembled with the housing 46 (from FIG. 3) and placed in a wall mount of an aircraft cabin will be described. A printed circuit board (PCB) 74 having many of the components shown and described in conjunction with FIG. 2 sits on the first shelf 56 and the third shelf 58 of the housing 46. The LEDs, such as the amber LED 27 and the blue LED 29, are mounted directly on the surface of the PCB 74, and conductive traces on the PCB 74 act as their leads. A lens 68 is snap-fit onto the housing 46 such that end portions 70 and 72 of the lens 68 make contact with the first and second lips 64 and 66 of the housing 46. Alternatively, the lens 68 may slide onto the housing 46. Note that the end portions 70 and 72 are shaped in a way that is complimentary to the first and second lips 64 and 66. The housing 46 is secured into a wall mount 76 in such a way that it is prevented from falling out. The housing 46 may be rotated within the wall mount 76 so that the light emanating from the light unit can be oriented in the desired direction. In FIG. 6B, drive circuitry 75 is also depicted. The drive circuitry 75 includes the driver stages of FIG. 2, as well as other components. To dissipate heat from the drive circuitry 75, a thermally conductive material 77 is provided. The thermally conductive material 77 is disposed between the drive circuitry 75 and the bottom 52 of the housing 46, and contacts both the drive circuitry 75 and the bottom 52. Heat generated by the drive circuitry 75 is conducted through the thermally conductive material 77, through the housing, and is radiated from the housing by the fins 54.

Various features and advantages of the wash lighting system will now be described. It is to be understood that not all embodiments are required to have all of these features and advantages. In fact, some embodiments may implement all of the them, while other embodiments may implement less than all of them.

The wash lighting system described herein may offer not only increased light output, but also the capability to customize the cabin environment through tailored lighting. All of these features are enclosed in a light weight, rugged package which is fully compliant with FAA FARs and RTCA DO-160D requirements. This technology may be offered either as a basic product designed to match the electrical parameters of existing wash light units, or as a luxury product with an extended array of features.

The wash lighting system described herein may take advantage of improved performance and packaging of the individual LED components. LED manufacturers have been able to increase the efficiency of these devices achieving increased light output from smaller packages. These new electronic devices radiate more light, and also offer a wider angular dispersion of the light output. The lighting unit structure described herein leverages this wide dispersion to implement light mixing, which produces a lighting effect that is even in flux and color temperature along the unit's length. It also reduces the sensitivity of an installation to slight variations in the angular position of the lighting units, more closely mimicking the lighting effect of the traditional, non-directional fluorescent tubes.

If packaged as a luxury product, the wash lighting system described herein adds unique options for customizing the lighting effect within the cabin. With the increased light output of the white LED and the smaller footprint of the individual devices comes the opportunity to add other light producing circuitry without growing the product envelope. The wash lighting system may also offer the option to select color temperature either at installation or to during flight. Color temperature can be used to create an energized work environment by shifting towards a cool light, or to create a relaxed, comfortable atmosphere by shifting towards warm. This warm or cool effect is integrated with dimming controls to ensure that color temperature remains consistent from full bright through the full range of dimming.

The light emitted by the lighting system may also provide night-lighting options. The system may, for example offer two options for dark cabin lighting. For a passenger cabin, an integral blue night light can be illuminated to provide a restful night sky effect conducive to sleep. In other areas such as the galley, flight personnel may require light to work in an overall dark interior, and therefore use an integral red work light.

If deployed on an aircraft, it is contemplated that the wash lighting system will comply with the high levels of performance, quality, and reliability required to pass RTCA DO-160D testing, and will meet the rigorous power input and EMI test specifications, as well as the environmental requirements. Features such as temperature compensation circuitry are preferably included in both the basic package and the luxury package.

The wash lighting system described herein takes advantage of the internal microprocessor carried in each unit to integrate additional features made possible by RS-485 control. For example, one digital dimmer can communicate with and control an installation of up to 200 units. Digital signals also ensure that each lighting unit interprets the dimming commands the same way. Combined with pulse width modulated LED drivers, the digital system provides unparalleled consistency between lighting units even at low light levels.

In addition to carrying control commands for light parameters such as color temperature or night lighting, the RS-485 is capable of transmitting built in test (BIT) information back to the central digital dimmer. Expansion of these capabilities can allow customization to communicate with various CMS systems.

The mechanical structure of each wash light unit addresses the challenge of dissipating the heat generated by brighter LED devices while reducing weight by more than 20% compared to previous designs. Heat travels to the outside surfaces through the aluminum housing, custom designed to minimize product size and weight. This housing incorporates a finned section along the bottom surface, maximizing heat removal and ensuring that the unit may be installed in small spaces without the need for forced air cooling. The black painted finish further improves heat transfer efficiency and is compliant with performance criteria set forth in Boeing BMS 10-83D and the FAA FAR 2.

One package design (shown in FIGS. 6A and 6B) has a snap-in installation design favored for fluorescent systems. Optionally, a slim profile clip may be used to further reduce the space requirements, thereby contributing to maximized cabin space in new interiors.

In one implementation, the wash lighting system described herein has the following technical specifications:

Voltage: 28VDC

Weight: 2.2 oz. per foot
Lengths: 9.0, 10.5, 12.0, 28.5, 30.0 inches

Mounting System: P/N 5661-00 Clip or Slim Clip

| | Basic package | Luxury package |
|---|---|---|
| Light Output at Full Bright | 125 ft-candles | 230 ft-candles |
| Cool White | | |
| Input Power at Full Bright | 5.4 W | 10.2 W |
| Cool White | | |
| Color Temperature Options | 2500, 3500, 4500° K | Adjustable |
| (from factory) | | |
| Add-on Color Options | N/A | Blue or Red |
| Control Signal | 28 V PWM | RS-485 |
| | Continuous Dimming | |
| Dimmer Module | P/N AL-2014 or | P/N AL-2014 or |
| | P/N AL-2024 | P/N AL-2024 |
| Lighting Units per | 40 | 200 |
| Dimmer Module | | |

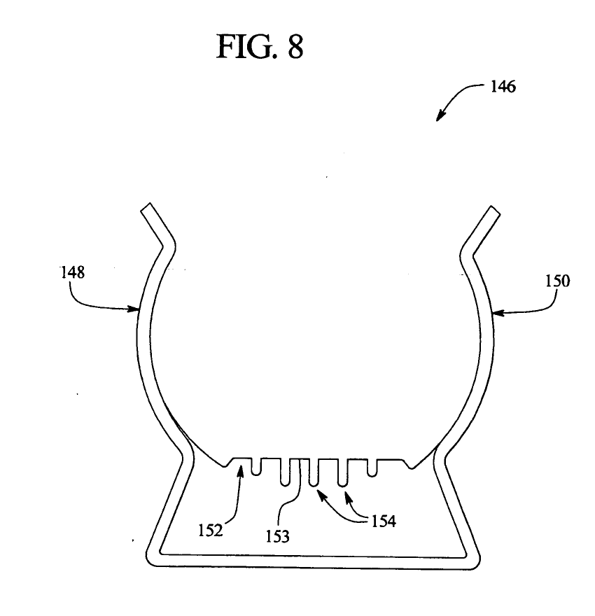

The wash lighting described herein may be implemented with a mechanical structure that addresses the challenge of dissipating the heat generated by LED devices. One such implementation will now be described with reference to FIG. 8. As shown in FIG. 8, each light unit of the wash lighting system may be disposed within a housing 146. The housing 146, which may be made of an aluminum alloy, has a first arcuate side 148, a second arcuate side 150, and a substantially straight bottom 152. The housing 146 is open at the top, with the bottom 152 located between, and formed into a unitary body with, the first side 148 and the second side 150. Heat travels to the outside surfaces through the housing 146. The bottom 152 has an outer surface 153 from which a series of fins 154 extends. The finned surface maximizes heat removal and ensures that the unit may be installed in small spaces without the need for forced air cooling. The housing 146 has a black finish which further improves heat transfer efficiency and is compliant with performance criteria set forth in Boeing BMS 10-83D and the FAA FAR 2.

In some implementations, the wash lighting system described herein takes advantage of improved performance and packaging of the individual LED components. Because surface mount LED devices radiate a wide angular dispersion of light output, which is leveraged by the lighting unit's structure to promote light mixing, this produces an even lighting effect along the unit's length. Light mixing also reduces the sensitivity of an installation to slight variations in the angular position of the lighting units. This functionality is enclosed in a light weight, rugged package which is fully compliant with FAA FARs and RTCA DO-160D requirements.

As noted above, the invention is also directed to a method and apparatus for adjusting an LED light of the lighting system. When implemented in an aircraft-based wash lighting system, the adjusting method and apparatus maintains a smooth and even wash while incorporating a newly installed light into an older installation. Microprocessor circuitry within each lighting unit can learn and memorize a customized maximum light output level. This allows a new light to be installed into an older wash and then set to a new maximum light output matched to that installation by the maintenance technician.

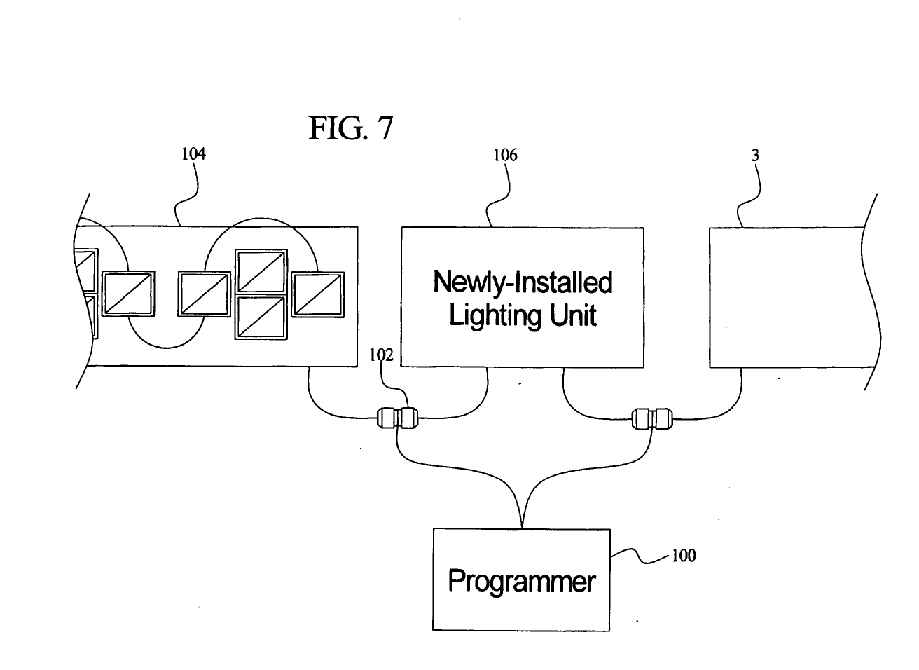

Referring to FIG. 7, an embodiment of the adjustment method and apparatus will now be described. In FIG. 7, there is depicted a previously-installed lighting unit 104 and a newly-installed lighting unit 106. These lighting units configured like the lighting unit 3 of FIG. 1. It is assumed in this example that a technician has removed a defective lighting unit and replaced it with the newly-installed lighting unit 106. The technician connects a portable programmer 100 to an already installed light unit 104 and to the newly installed light unit 106 using an RS-485 plug 102. The technician then uses the programmer 100 to adjust the tint and intensity of the various LEDs in the newly installed light unit 106 until they come acceptably close to the tint and intensity of the LEDs in the already installed light unit 104. The programmer 100 sends signals to the microcontroller 12 (FIG. 2) of the newly installed light unit 106. The microcontroller 12 interprets those signals and adjusts the signals being sent to the driver stage 24 and the digital potentiometers. In one implementation, the microcontroller 12 maintains a look-up table in its memory, which has a set of calibration values. In another implementation, the microcontroller 12 “memorizes” the tint of the lights that it currently controls. There are a variety of ways in which this adjustment may occur. In one embodiment, the technician simply looks at the newly installed light unit 106 and keeps adjusting with the programmer 100 until the technician perceives that the newly installed light unit 106 appears the same as the already installed light unit 104. In another embodiment, the microprocessor 12 of the already installed light unit 104 maintains data regarding the tint and color of the light that it is emitting, and transmits this data to the programmer 100. The programmer 100 then executes a program to convert the data into tint and intensity data for the newly installed light unit 106. Using the converted data, the microprocessor 12 of the newly installed light unit 106 automatically adjusts the tint and intensity of its LEDs on its own. In yet another embodiment, the programmer 100 has a photosensitive element that perceives the tint and intensity of the light being emitted from the already installed light unit 104, converts that information into data signals, which are then processed by a microcontroller in the programmer 100. In processing the data signals, the programmer 100 generates data that can be used by the newly installed light unit 106 to generate light that is acceptably close in tint and intensity to the light being emitted by the already installed light unit 104.

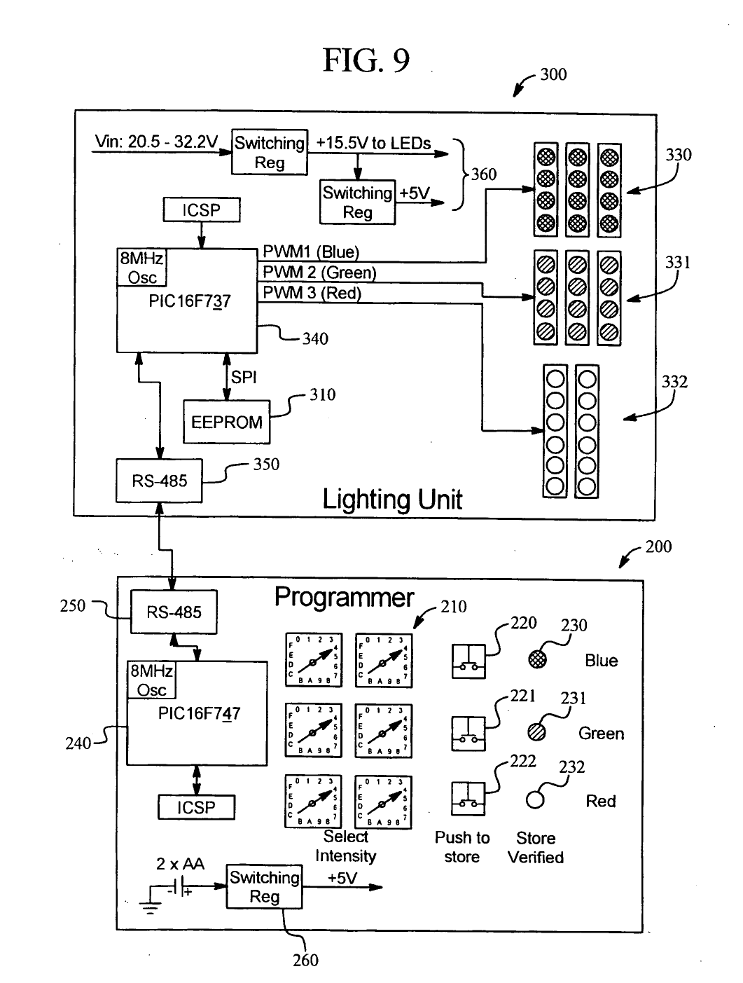

Referring to FIG. 9, an embodiment of the programmer 100 (from FIG. 7) will now be described. This embodiment, generally labeled 200, is communicatively linked to a wash lighting unit 300. The programmer 200 includes controls 210 for selecting the intensity of each color of LED, a separate button 220, 221 and 222 for each color of LED, that, when pushed by a user, will store the color intensity selected by the user. The programmer 200 also includes indicator lights 230, 231 and 232 to provide visual verification that the selection has been stored. The programmer 200 also includes a microcontroller 240, an RS-485 integrated circuit (IC) 250 and a switching regulator 260. The wash lighting unit 300 includes microcontroller 340, an IC 350 an EEPROM 310, strings of blue 330, green 331 and red LEDs 332, and an input power conditioning unit and associated switching regulators 360.

The microcontroller 240 of the programmer 200 is communicatively linked via the IC 250 to the IC 350 of the lighting unit 300 and ultimately to the wash lighting unit's microcontroller 340. The microcontroller 340 of the wash lighting unit is communicatively linked to the EEPROM 310 and the strings of red 332, blue 330 and green 331 LEDs. The programmer 200 transmits the color and intensity data for each color of LED to the lighting unit 300 via the RS-485 link. The microcontroller 340 of the lighting unit 300 receives the information and stores it in the EEPROM 310.

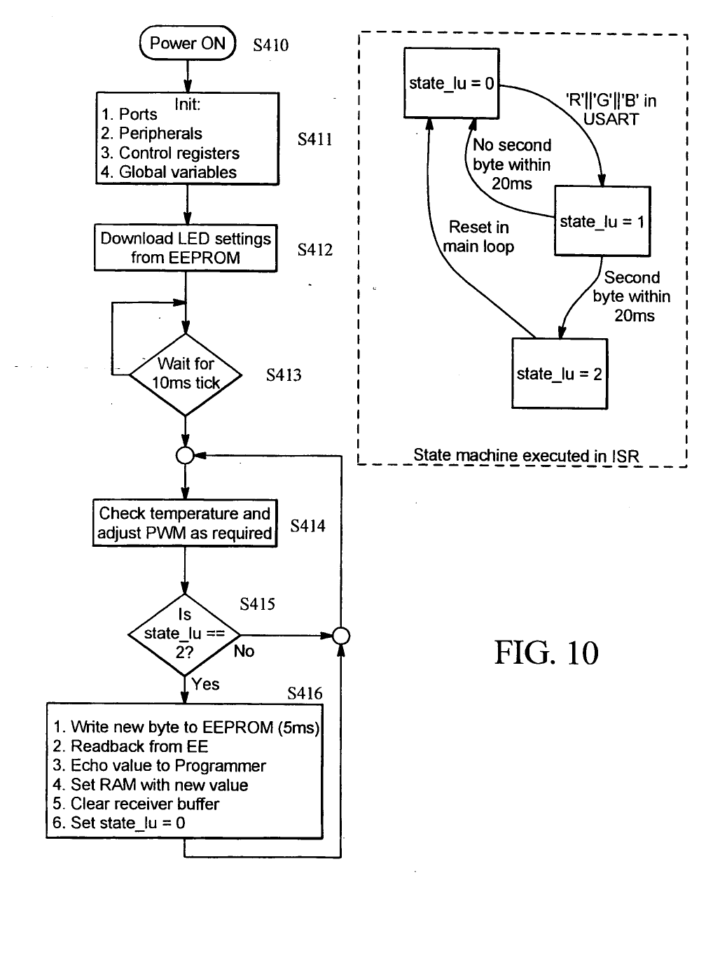

Referring to FIG. 10, an example of the steps performed by the programmer 200 when the programmer 200 is communicatively linked to the lighting unit 300 will now be described. When power is applied to the lighting unit (S410), the unit initializes the ports, peripherals, the control registers, and the global variables (S411). The color and intensity information is downloaded (S412, S413) from the EEPROM 310 to the microcontroller 340, which generates and transmits the appropriate PWM signals for the desired color intensity to the appropriate strings of LEDs for each color. In doing so, the temperature is checked and the PWM signal is adjusted as required (S414). Communication between the lighting unit 300 and the programmer 200 occurs according to the state machine depicted in FIG. 10. This state machine may be executed as part of an interrupt service routine.

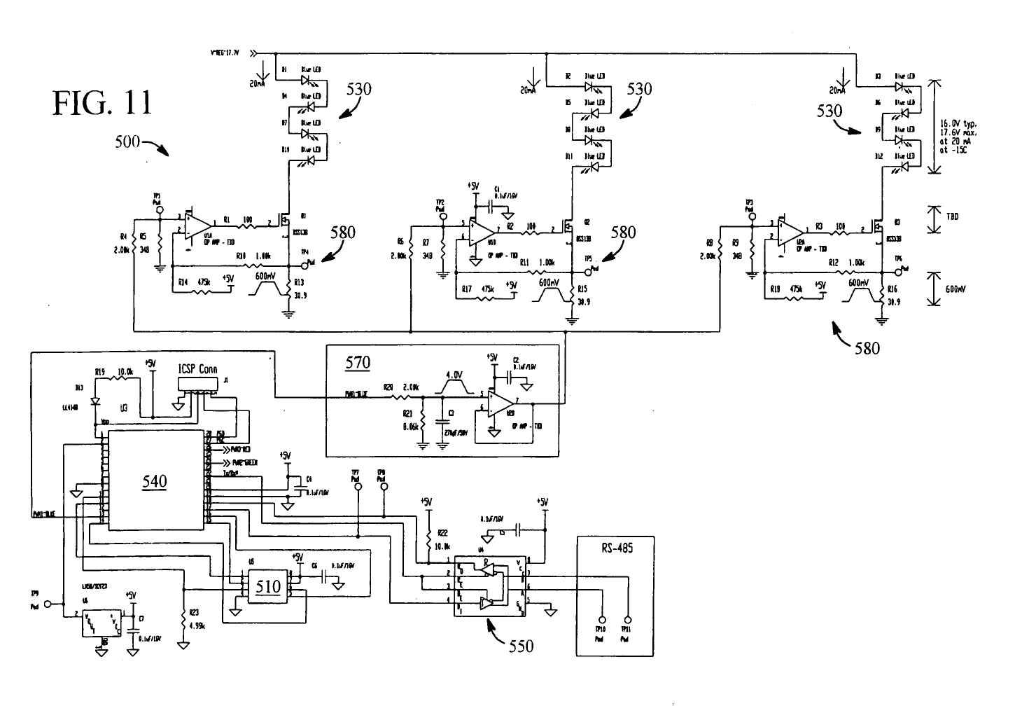

An example of electrical circuitry that may be used in the various embodiments of the lighting units (from FIGS. 1, 1A, 2, 7, and 9) will now be described with reference to FIG. 11. The circuitry, generally labeled 500, includes a microcontroller 540 communicatively linked to an IC 550, a power supply that provides power to the microcontroller 540, and an EEPROM 510 that stores the LED settings. A pair of RS-985 wires links the IC 550 to external devices, such as other lighting units or programmers, and carries control and data signals to the IC 550. The control and data signals represent color and intensity information. The IC 550 provides the control and data signals to the microcontroller 540 in a form understandable to the microcontroller 540. In an embodiment of the invention, a separate microcontroller 540 and EEPROM 510 are contained in each individual wash lighting unit. The microcontroller 540 pins are defined in Table A.

TABLE A

| | |
|---|---|
| 1 | \overline{MCLR}/Vpp/RE3 |
| 2 | RA0/AN0 |
| 3 | RA1/AN1 |
| 4 | RA2/AN2/Vref-/CVref |
| 5 | RA3/AN3/Vref |
| 6 | RA4/T0CKI/C1OUT |
| 7 | RA5/AN4/LVDIN/\overline{SS}/C2OUT |
| 8 | Vss |
| 9 | OSC1/CLKIN/RA7 |
| 10 | OSC2/CLKO/RA6 |
| 11 | RC0/T1OSO/T1CKI |
| 12 | RC1/T1OSI/CCP2(1) |
| 13 | RC2/CCP1 |
| 14 | RC3/SCK/SCL |
| 15 | RC4/SDI/SDA |
| 16 | RC5/SDO |
| 17 | RC6/TX/CK |
| 18 | RC7/RX/DT |
| 19 | Vss |
| 20 | Vdd |
| 21 | RB0/INT/AN12 |
| 22 | RB1/AN10 |
| 23 | RB2/AN6 |
| 24 | RB3/CCP2(1)/AN9 |
| 25 | RB4/AN11 |
| 26 | RB5/AN13/CCP3 |
| 27 | RB6/PGC |
| 28 | RB7/PGD |

The EEPROM 510 pins are defined in Table B.

| | |
|---|---|
| 1 | \overline{CS} |
| 2 | SO |
| 3 | \overline{WP} |
| 4 | Vss |
| 5 | SI |
| 6 | SCK |
| 7 | \overline{HOLD} |
| 8 | Vcc |

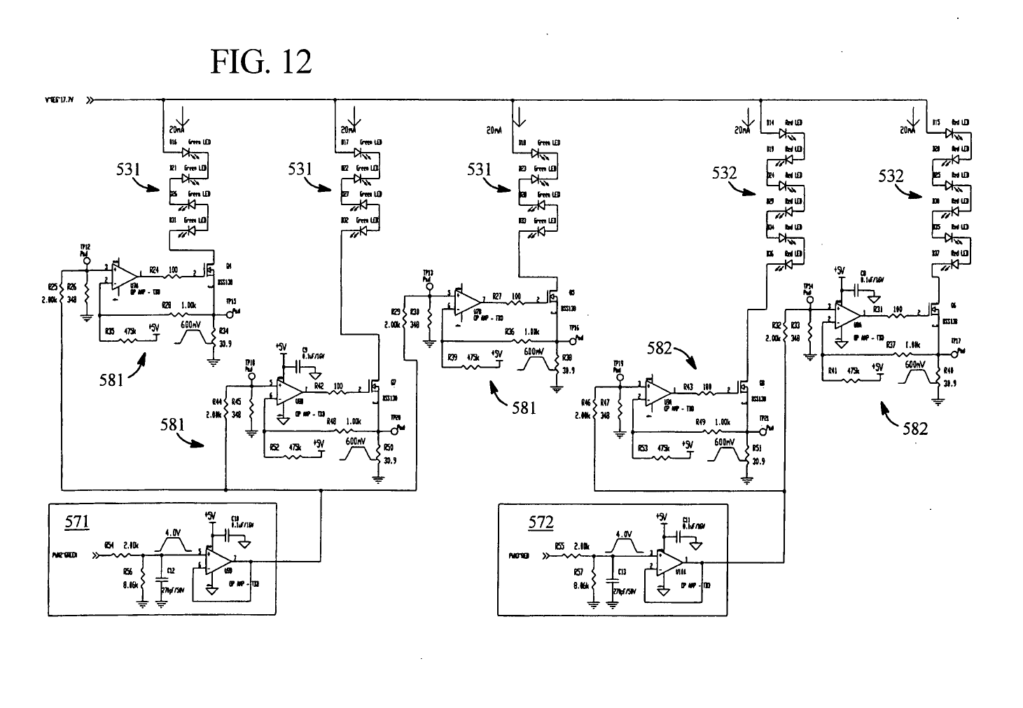

The circuitry 500 includes slew rate controls 570 (FIG. 11), 571 (FIG. 12) and 572 (FIG. 12). The slew rate controls 570, 571 and 572 are electrically coupled to the microcontroller 540. In an embodiment of the invention, the signals from the slew rate controls 570, 571 and 572, which represent the desired color and intensity of the LEDs, are used as inputs to the LEDs 530 (FIG. 11), 531 (FIG. 12) and 532 (FIG. 12).

The LEDs that provide illumination for the red, blue and green lights of each individual wash lighting unit (FIG. 8) are depicted in FIG. 9 as red LEDs 332, blue LEDs 330, and green LEDs 331. The red LEDs 332, blue LEDs 330, and green LEDs 331 are each driven by reprective driver stages 582 (FIG. 12), 580 (FIG. 11) and 581 (FIG. 12). Although there are many possible ways to apportion driver stages among LEDs, according to one embodiment, one drives four LEDs.

Referrring again to FIG. 11 and FIG. 12, the slew rate controls 570, 571 and 572 receive pulse width modulated (PWM) signals from the microcontroller 540, conditions those signals, and transmits the conditioned signals to the appropriate driver stage for the red LEDs 582, blue LEDs 580 and the green LEDs 581. In conditioning the signals, the slew rate controls smooth the edges of the PWM signals generated by the microcontroller 540 so as to reduce electromagnetic interference (EMI).

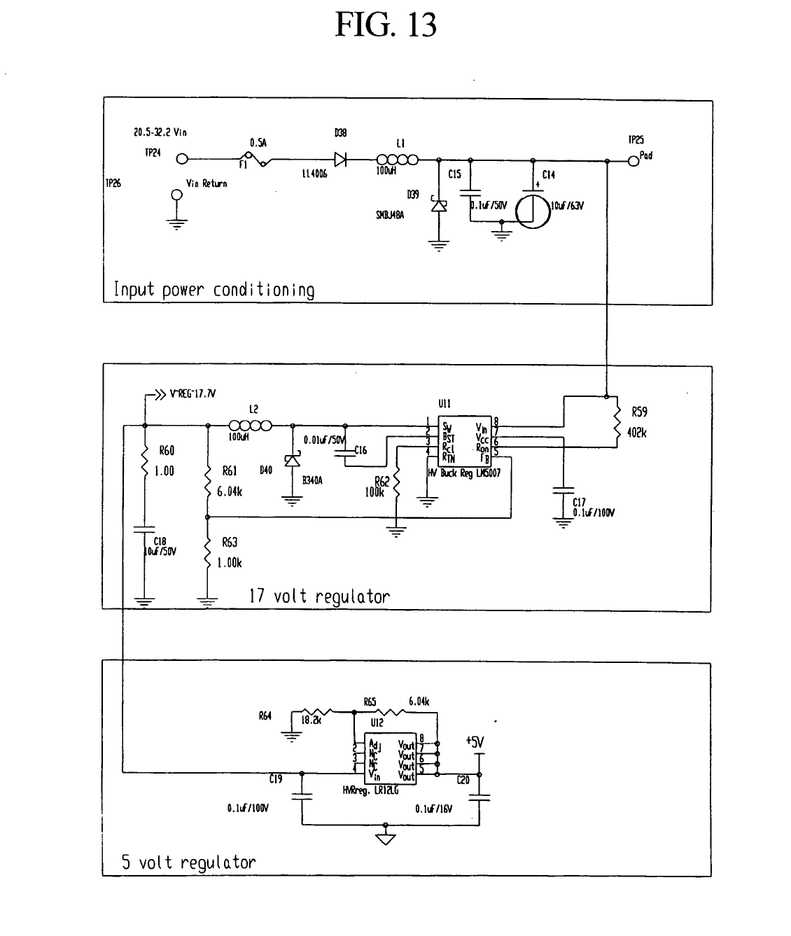

The LEDs of each color are electrically connected in a series of strungs. For example, groups of the LEDs of a light unit are connected in a series string, groups of the blue LEDs of the light unit are connected in a series string, and groups of the green LEDs of a light unit are connected in a series string. For each series string of LEDs, the driver stage is electrically connected at one end and a switching regulator is connected to the other end. The switching regulator serves multiple light units. An embodiment of the input power conditioning circuit and the associated voltage regulators is shown in FIG. 13.

Although example embodiments of the present invention have been described in detail, those skilled in the art will readily appreciate that many modifications are possible to these embodiments without materially departing from the invention. Accordingly, all such modifications are intended to be included within the scope of this invention.

The use of the terms “a” and “an” and “the” and similar referents in the context of describing the invention (especially in the context of the following claims) are to be construed to cover both the singular and the plural, unless otherwise indicated. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A method for adjusting an LED lighting unit, the lighting unit comprising a plurality of LEDs, the method comprising:
connecting a programmer to the lighting unit;
inputting lighting information into the programmer;
transmitting data representing the lighting information from the programming device to the lighting unit; and
storing the data in the lighting unit, wherein one or more of the plurality of LEDs emit light that corresponds to the transmitted data.

2. The method of claim 1, wherein the color of the one or more of the plurality of LEDs changes after completion of the storing step, the method further comprising
observing the light being emitted by the one or more of the plurality of LEDs;
determining that the light being emitted by the one or more of the plurality of LEDs is not the correct color; and
based on the determining step, inputting new lighting information into the programmer.

3. The method of claim 1, further comprising:
comparing the color being emitted by the lighting unit to one or more other lighting units; and
based on the comparing step, determining what information is to be input during the inputting step.

4. The method of claim 1 wherein the information comprises color information.

5. The method of claim 1 wherein the lighting unit contains a microprocessor that transmits to the plurality of LEDs a signal representative of the data received from the programmer.

6. The method of claim 1 wherein the information comprises brightness information.

7. The method of claim 1 further comprising activating a user input mechanism that triggers the storing of the data in the lighting unit.

8. The method of claim 1, wherein the lighting unit is a first lighting unit, and wherein the inputting step comprises connecting the programmer to a second lighting unit, and transferring the lighting information from the second lighting unit to the first lighting unit.

9. The method of claim 1, wherein the inputting step comprises inputting color information and inputting brightness information.

10. An apparatus for adjusting an LED lighting unit, the apparatus comprising:
an input mechanism that receives lighting information, the lighting information representing a characteristic of the light that is supposed to be emitted from the LED lighting unit;
a memory that stores the received lighting information;
a feedback mechanism that shows the user what lighting information has been received from the user;
an interface that connects to the LED lighting unit; and
a controller that processes the received lighting information, retrieves the lighting information from the memory, and transmits the information to the LED lighting unit via the interface.

11. The apparatus of claim 10 wherein the input mechanism is comprised of a plurality of controls, each control being associated with a different color of LED of the lighting unit.

12. The apparatus of claim 10 wherein the input mechanism is selected from the group consisting of buttons, switches, levers, dials, and knobs.

13. The apparatus of claim 10, wherein the LED lighting unit is a first lighting unit, wherein the input mechanism is an interface that connects to a second LED lighting unit, wherein the controller executes software for performing the step of, downloading the lighting information from the second LED lighting unit.

14. The apparatus of claim 10, wherein the lighting information is information regarding the color of LEDs in the lighting unit.

15. The apparatus of claim 10, further comprising a mechanism that indicates whether the lighting information has been stored.

16. The apparatus of claim 10, wherein lighting information is information regarding the color and brightness of LEDs of the lighting unit.

17. The apparatus of claim 16, wherein the color and brightness information is for LEDs of at least three different colors.

18. The apparatus of claim 10, wherein the apparatus is a portable hand held unit.

19. A lighting system comprising:
a programmer further comprising:
a user input mechanism that receives color and brightness information from a user;
a communications interface; and
a microcontroller that transmits the color and brightness information via the communications interface;
a lighting unit coupled to the programmer, the lighting unit comprising:
a communications interface;
a microcontroller that receives the color and brightness information via the communications interface of the lighting unit and transmits a pulse width modulated signal representative of the color and brightness information;
one or more light emitting diodes that receive the pulse width modulated signal and emit light in response thereto; and
a memory for storing the color and brightness information.

20. The system of claim 19, further comprising a feedback mechanism that indicates to the user whether the color and brightness information has been transmitted from the programmer to the lighting unit.
